(19) United States
(12) Patent Application Publication
(10) Pub. No.: US 2023/0147151 A1
(43) Pub. Date: May 11, 2023

(54) Charging Apparatus and Method Using Auxiliary Battery

(71) Applicants: Hyundai Motor Company, Seoul (KR); Kia Corporation, Seoul (KR)

(72) Inventor: Min-Seong Choi, Hwaseong-si (KR)

(21) Appl. No.: 17/867,965

(22) Filed: Jul. 19, 2022

(30) Foreign Application Priority Data
Nov. 10, 2021 (KR) 10-2021-0153877

(51) Int. Cl. H02J 7/34; H02J 7/04; H02J 7/00

(52) U.S. Cl. CPC H02J 7/342; H02J 7/04; H02J 7/00712

(57) ABSTRACT

An embodiment charging apparatus includes a main battery, a charger configured to generate an initial charging power source by receiving a direct current (DC) power source from an auxiliary battery installed separately from the main battery or by receiving an alternating current (AC) power source to execute an initial charging operation, and a first switch configured to block or conduct an electrical connection between the auxiliary battery and the charger to thereby execute the initial charging operation depending upon whether the AC power source is supplied. The initial charging operation is terminated when the initial charging power source reaches a preset reference value calculated by multiplying an output power source of the main battery by a preset setting value.

### CROSS-REFERENCE TO RELATED APPLICATIONS

This application claims the benefit of Korean Patent Application No. 10-2021-0153877, filed on Nov. 10, 2021, which application is hereby incorporated herein by reference.

### TECHNICAL FIELD

The present disclosure relates to a charging technology.

### BACKGROUND

In general, a charger (on board charger (OBC)) using a commercial alternating current (AC) power source for charging a high voltage battery is mounted in a vehicle. The charger is generally composed of a power factor correction (PFC) circuit configured to correct a power factor of the commercial AC power source and a direct current/direct current (DC/DC) converter configured to convert a voltage into a voltage required by the battery.

The charger is connected to a main battery, and relays are configured in the main battery to protect the battery and devices using the battery as a power source. Among them, in particular, an initial charging circuit is a circuit that is essentially applied to stably supply a voltage to peripheral components such as an inverter.

In particular, it is possible to prevent an excessive inrush current and minimize resonance that can occur when a high voltage is supplied by using the initial charging circuit.

A bidirectional low voltage DC-DC converter (LDC) is used to delete this initial charging circuit. However, to delete the initial charging circuit using the bidirectional LDC, the bidirectional LDC should be operated by changing the LDC power flow. The LDC power flow is as follows: the main battery→the auxiliary battery to the auxiliary battery→the main battery.

Therefore, there is a disadvantage in that the original LDC operation of charging the auxiliary battery using the main battery is impossible while the initial charging operation is performed by using the bidirectional LDC.

The contents described in the background are to help the understanding of the background of the present disclosure, and may include what is not previously known to those skilled in the art to which the present disclosure pertains.

### SUMMARY

The present disclosure relates to a charging technology. Particular embodiments relate to an apparatus and a method for performing charging by deleting an initial charging circuit and using an auxiliary battery.

Embodiments of the present disclosure can solve problems in the art, and an embodiment of the present disclosure provides a charging apparatus and method, which can delete an initial charging circuit even without using a bidirectional converter.

In addition, another embodiment of the present disclosure provides a charging apparatus and method, which can perform an initial charging using an auxiliary battery.

Embodiments of the present disclosure provide a charging apparatus, which can delete an initial charging circuit even without using a bidirectional converter.

The charging apparatus includes a main battery, a charger configured to generate an initial charging power source by receiving a direct current (DC) power source from the auxiliary battery installed in a vehicle separately from the main battery or receiving an alternating current (AC) power source to execute an initial charging operation, and a first switch configured to block or conduct an electrical connection between the auxiliary battery and the charger to execute the initial charging operation depending upon whether the AC power source is supplied.

At this time, when the AC power source is not supplied, the first switch is turned on to conduct the electrical connection between the auxiliary battery and the charger.

In addition, the initial charging operation performs an initial charging by turning on the first switch and adjusting the duties of a boosting switch for boosting configured in a correction unit of the charger and a primary side switch configured in a conversion unit of the charger.

In addition, a second switch disposed between the main battery and the connection terminal is changed from OFF to ON depending upon a comparison result by comparing the initial charging power source generated on a connection terminal connected to the main battery by executing the initial charging operation with the preset reference value.

In addition, the preset reference value is calculated by multiplying an output power source of the main battery by a preset setting value.

In addition, the second switch is connected between the connection terminal and the main battery with the same polarity, and includes a first sub-switch and a second sub-switch arranged in parallel.

In addition, a low voltage direct current-direct current converter (LDC) among power components connected to the connection terminal is a unidirectional LDC.

In addition, the first switch is turned on when the vehicle travels or requires the initial charging.

In addition, the charger is a unidirectional charger.

In addition, when the AC power source is supplied, the first switch is turned off to block the electrical connection between the auxiliary battery and the charger.

In addition, the initial charging operation performs the initial charging by turning off the first switch and adjusting the duties of a boosting switch for boosting configured in a correction unit of the charger and a primary side switch configured in a conversion unit of the charger.

On the other hand, another exemplary embodiment of the present disclosure provides a charging method using an auxiliary battery including switching to block or conduct an electrical connection between the auxiliary battery and a charger using a first switch depending upon whether an alternating current (AC) power source is supplied and executing an initial charging operation by receiving a direct current (DC) power source from the auxiliary battery using the charger installed in a vehicle or receiving the AC power source to generate an initial charging power source.

In addition, the switching includes conducting the electrical connection between the auxiliary battery and the charger by turning on the first switch when the AC power source is not supplied.

In addition, after the executing of the initial charging operation, the charging method includes comparing, by the control unit, a charging power source generated on a connection terminal connected to a main battery by executing the initial charging operation with a preset reference value and changing, by the control unit, a second switch disposed between the main battery and the connection terminal from OFF to ON depending upon the comparison result.

In addition, the switching includes blocking the electrical connection between the auxiliary battery and the charger by turning off the first switch when the AC power source is supplied.

According to embodiments of the present disclosure, it is possible to delete the initial charging circuit between the main battery and the connection terminal by adding the switching element between the input terminal of the charger and the auxiliary battery.

In addition, as another embodiment of the present disclosure, the added switching element, as the relay, can be cheaper and smaller than the initial charging circuit of the connection terminal, thereby reducing the cost and/or the size.

### BRIEF DESCRIPTION OF THE DRAWINGS

FIG. 1 is a block diagram showing a configuration of a charging apparatus using an auxiliary battery according to an exemplary embodiment of the present disclosure and a concept diagram of a circuit operation in a traveling situation.

FIG. 2 is a block diagram showing the configuration of the charging apparatus using the auxiliary battery according to an exemplary embodiment of the present disclosure and a concept diagram of a circuit operation in a charging situation.

FIG. 3 is a concept diagram showing an initial charging operation of a connection terminal connected to a main battery in a slow charging situation as an example of the circuit diagram of the charging apparatus shown in FIG. 2.

FIG. 4 is a result graph according to the setting of input values based on FIG. 3.

FIG. 5 is a result graph according to another setting of the input values based on FIG. 3.

FIG. 6 is a concept diagram showing the initial charging operation of the connection terminal connected to the main battery in a traveling situation as an example of the circuit diagram of the charging apparatus shown in FIG. 1.

FIG. 7 is a result graph according to the setting of input values based on FIG. 6.

FIG. 8 is a flowchart showing a process of performing the initial charging without an initial charging circuit using the auxiliary battery according to an exemplary embodiment of the present disclosure.

### DETAILED DESCRIPTION OF ILLUSTRATIVE EMBODIMENTS

The aforementioned objects, features, and advantages will be described later in detail with reference to the accompanying drawings, and therefore, those skilled in the art to which the present disclosure pertains can easily practice the technical spirit of the present disclosure. In describing embodiments of the present disclosure, if it is determined that a detailed description of a known technology related to the present disclosure can unnecessarily obscure the gist of the present disclosure, the detailed description thereof will be omitted. Hereinafter, preferred exemplary embodiments of the present disclosure will be described in detail with reference to the accompanying drawings. In the drawings, the same reference numerals are used to indicate the same or similar components.

Hereinafter, a charging apparatus and method using an auxiliary battery according to an exemplary embodiment of the present disclosure will be described in detail with reference to the accompanying drawings.

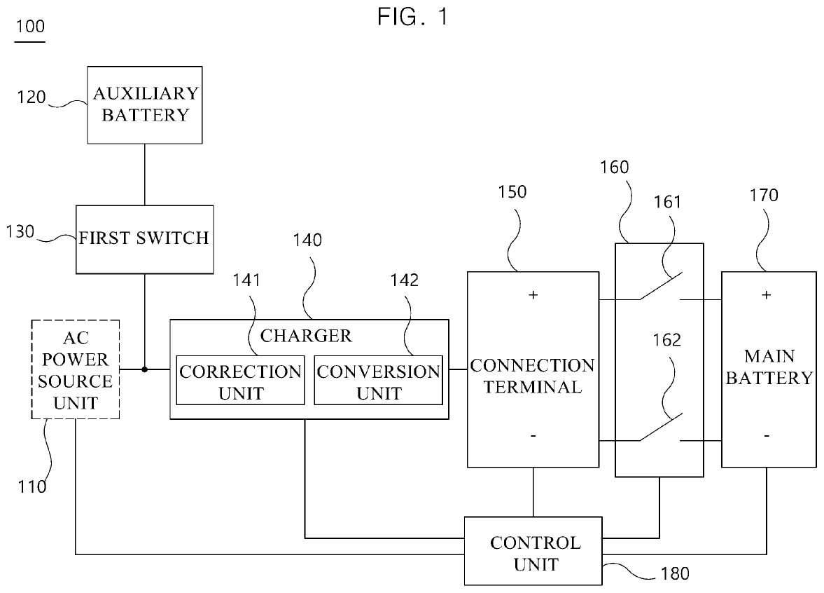

FIG. 1 is a block diagram showing a configuration of a charging apparatus 100 using an auxiliary battery 120 according to an exemplary embodiment of the present disclosure and a concept diagram of a circuit operation in a traveling situation. Referring to FIG. 1, the charging apparatus 100 can be configured to include an alternating current (AC) power source unit 110, an auxiliary battery 120, a first switch 130, a charger 140, a connection terminal 150, a second switch 160, a main battery 170, and a control unit 180.

The AC power source unit no serves to receive an AC system power source. In general, a rectifying circuit is configured in the charger 140. Therefore, the AC power source unit no serves to supply the AC power source to the charger 140.

Of course, the rectifying circuit can be configured in the AC power source unit 110. In this case, the AC power source unit no can convert the AC power source into a DC power source to supply the DC power source. In this case, the rectifying circuit cannot be configured in the charger 140.

The AC power source unit 110 can receive a commercial AC power source. Each country has a different commercial AC power source. Representatively, the commercial AC power source is 230 VAC/50 Hz in EU, 240 VAC/60 Hz in North America, and 220 VAC/60 Hz in Korea.

The auxiliary battery 120 serves to supply the direct current (DC) power source as a low-voltage battery. The auxiliary battery 120 is a low-voltage power source battery for driving an electric part load (not shown) and generally uses a 12V-level voltage. The auxiliary battery 120 can include a chargeable battery cell, a super capacitor, etc.

The first switch 130 serves to block or allow the DC power source to flow into the charger 140 from the auxiliary battery 120. In other words, the first switch 130 is turned off to become a blocking state and is turned on to become a conduction state. To this end, as the first switch 130, a relay switch is mainly used but the present disclosure is not limited thereto, and a semiconductor switching element such as a field effect transistor (FET) or a metal oxide semiconductor FET (MOSFET) can also be used.

The charger 140 can be a unidirectional on board charger (OBC) mounted in a vehicle. Therefore, the charger 140 can be configured to include a correction unit 141 configured to correct a power factor of the power source, and a conversion unit 142 configured to convert the DC power source into a smaller DC power source. Of course, the correction unit 141 can be configured to include the rectifying circuit. In this case, the correction unit 141 can serve to convert the AC power source directly introduced from the AC power source unit no into the DC power source and to improve the power factor. Therefore, the correction unit 141 can be provided with a power factor correction (PFC) circuit.

The conversion unit 142 can be configured to include a DC-DC converter to convert the DC power source into the smaller DC power source.

The connection terminal 150 is connected to the main battery 170 to become a passage that delivers an output power source of the charger 140 to the main battery 170. Of course, the connection terminal 150 can be an input terminal of a low-voltage direct current (LDC) (not shown) or an input terminal of an inverter (not shown).

The LDC is a DC-DC converter configured to charge the auxiliary battery 120 through the main battery 170 to drive the electric part load (not shown). In addition, the inverter serves to convert the DC power source from the main battery 170 into the AC power source to supply the AC power source to a driving motor (not shown).

The second switch 160 is a main switch and conducts or blocks the DC power source to flow into the main battery 170. In addition, the second switch 160 conducts or blocks the DC power source output from the main battery 170. The second switch 160 can include a first sub-switch 161 and a second sub-switch 162. In general, an initial charging circuit has a structure in which a power relay (not shown) and a resistor (not shown) are configured in series and connected to the first sub-switch 161 in parallel. Of course, a positive temperature coefficient (PTC) element instead of the resistor is used. According to an exemplary embodiment of the present disclosure, it is possible to stably supply the power source to peripheral power components such as an inverter even while deleting this initial charging circuit.

As the second switch 160, the power relay is mainly used but the present disclosure is not limited thereto, and a semiconductor switching element such as a field effect transistor (FET), a metal oxide semiconductor FET (MOSFET), an insulated gate bipolar mode transistor (IGBT), a power rectifying diode, a thyristor, a gate turn-off (GTO) thyristor, a triode for alternating current (TRIAC), a silicon controlled rectifier (SCR), an integrated circuit (IC), etc. can be used.

In particular, for the semiconductor element, a bipolar transistor, a power metal oxide silicon field effect transistor (MOSFET) element, etc. can be used. The power MOSFET element performs a high-voltage and high-current operation and has a structure of a double-diffused metal oxide semiconductor (DMOS) unlike the general MOSFET.

The main battery 170 serves to supply the power source to the driving motor (not shown), the auxiliary battery 120, etc. In general, the power source of the main battery 170 is about 160 to 250 V for a hybrid electric vehicle (HEV) and about 400 to 800 V for a battery electric vehicle (BEV). Some cost-saving type electric vehicle systems can also share and use the grounds of the auxiliary battery and the main battery by designing the power source of the main battery as about 48 V level.

The main battery 170 can have the battery cells (not shown) configured in series and/or in parallel, and this battery cell can be a high-voltage battery cell for an electric vehicle such as a nickel metal battery cell, a lithium ion battery cell, a lithium polymer battery cell, a lithium-sulfur battery cell, a sodium-sulfur battery cell, or an all-solid-state battery cell. In general, the high-voltage battery refers to a battery with a high voltage of 100 V or more as the battery used as the power source that moves the electric vehicle.

The control unit 180 serves to control the ON/OFF of the first switch 130, the charger 140, and the second switch 160. In addition, the control unit 180 performs an algorithm that executes the initial charging operation when the vehicle travels or requires the initial charging. To this end, the control unit 180 can be configured to include a microprocessor, a microcomputer, a memory, etc.

The memory can be a memory provided in the control unit, and a separate memory. Therefore, the memory can be configured by combining a non-volatile memory such as a flash memory disk (solid state disk (SSD)), a flash memory, an electrically erasable programmable read-only memory (EEPROM), a static RAM (SRAM), a ferro-electric RAM (FRAM), a phase-change RAM (PRAM), a magnetic RAM (MRAM) and/or a volatile memory such as a dynamic random access memory (DRAM), a synchronous dynamic random access memory (SDRAM), or a double data rate-SDRAM (DDR-SDRAM).

In addition, the control unit 180 can be connected to a sensor (not shown) to measure a power generated by or input from each power component. The sensor can be installed inside or outside each power component. In particular, according to an exemplary embodiment of the present disclosure, the sensor can be installed on the AC power source unit no, the charger 140, the connection terminal 150, or the main battery 170. The sensor can be a current sensor, a voltage sensor, etc.

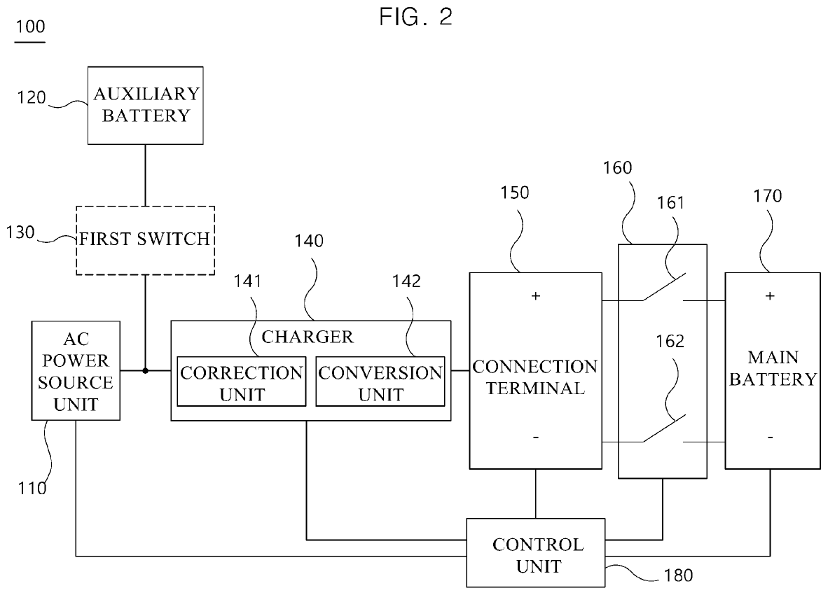

FIG. 2 is a block diagram showing the configuration of the charging apparatus 100 using the auxiliary battery 120 according to an exemplary embodiment of the present disclosure and a concept diagram of a circuit operation in a charging situation. FIG. 2 has the same configuration as the configuration of the charging apparatus shown in FIG. 1, but there is a difference in that the charger 140 receives the power source.

In other words, this is the operation of the charging apparatus 100 when the vehicle is in the charging state other than in the traveling state. Therefore, during charging, before charging, or for the initial charging on the connection terminal 150 connected to the main battery, the charger 140 is connected to the AC power source unit no to receive the power source (i.e., AC system power source). Of course, if the charger 140 is connected to the AC power source unit 10, the first switch 130 is turned off. The first switch 130 is turned on when the vehicle travels or requires the initial charging. In particular, the first switch 130 can use the relay element. In this case, since the first switch 130 uses the low voltage, the price is very cheap. The low voltage can be about 12 V to 48 V or less.

Continuously referring to FIG. 2, if the charger 140 is used for slow charging, the auxiliary battery 120 and the input terminal of the charger 140 cannot be connected. However, the charger 140 itself serves to deliver the power from the AC system power source to the main battery 170. Therefore, the charger 140 can replace the role of the initial charging circuit of the main battery 170 because it performs the original charging operation.

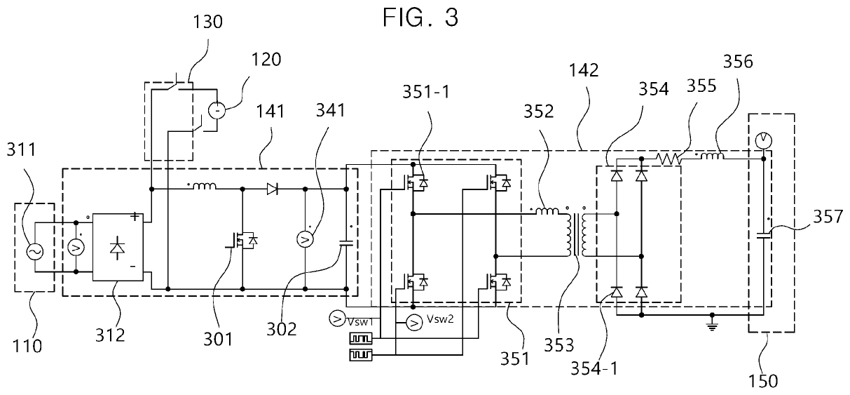

FIG. 3 is a concept diagram showing an initial charging operation of the connection terminal 150 connected to the main battery 170 in the slow charging situation as an example of the circuit diagram of the charging apparatus 100 shown in FIG. 2. Referring to FIG. 3, the initial charging of the connection terminal 150 connected to the main battery 170 in the slow charging operation is performed by turning off the first switch 130 connected to the charger 140 and adjusting the duties of a boosting switch 301 and a primary side switch 351-1 configured in a direct current-alternating current (DC-AC) converter 351. The AC system power source 311 is converted by the alternating current-direct current (AC-DC) converter 312, and the boosting switch 301 is turned on or off when the boosting of a link voltage 341 is required.

A front end of the direct current-alternating current (DC-AC) converter 351 is connected to a capacitor 302 for smoothing the link voltage in parallel. The output power source of the connection terminal 150 connected to the main battery 170 is adjusted by adjusting the duty of the primary side switch 351-1 configured in the DC-AC converter 351. In other words, the output voltage output by adjusting the duty of the primary side switch 351-1 is changed in size through an inductor 352 and a transformer 353 and converted back into the DC power source through a rectifier 354. The primary side switch 351-1 is formed of an FET and controls ON/OFF through a pulse width modulation (PWM) waveform. The primary side switches 351-1 are turned on when the input voltages are larger than reference voltages (Vsw1, Vsw2).

The rectifier 354 is a bridge circuit connecting four diodes 354-1.

The converted DC power source becomes the charging power source input to the main battery 170 by the capacitor 357 through a resistor 355 and an inductor 356. In other words, the charging power source is generated on the connection terminal 150.

When the power source of the connection terminal connected to the main battery and a reference power source are similar, the initial charging operation is terminated and the main switch (160 in FIG. 1) is turned on to connect the connection terminal with the main battery. For example, if the power source of the connection terminal is larger than the power source of the main battery×0.9, the initial charging operation is terminated, and the connection terminal and the main battery are electrically connected.

When the initial charging operation is terminated, the main battery 170 is charged by using the charger 140.

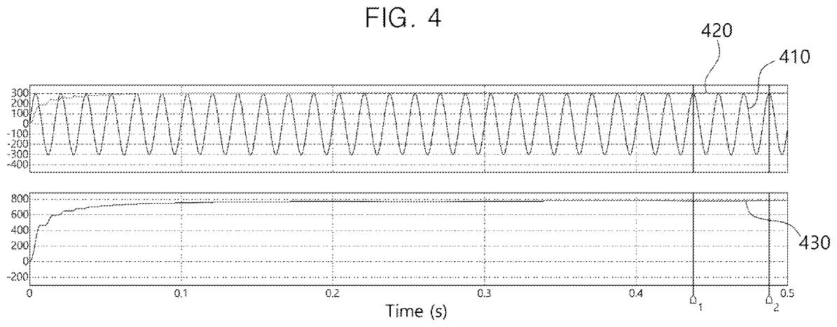

FIG. 4 is a result graph according to the setting of input values based on FIG. 3. Referring to FIG. 4, the setting of the input values is as follows.

AC input power source=220 Vrms (“rms” stands for root mean square)

PFC duty=0 (“PFC” stands for Power Factor Correction)

DC-DC duty=0.47

Link voltage (Vlink)=308 V

Main battery power source (VHVB)=778 V

Continuously referring to FIG. 4, for the top graph, as a charger input voltage 410 is input within a range of about +300 to −300 V, a charger link voltage 420 initially increases rapidly but becomes almost flat as it approaches 0.1 seconds, and becomes a flat state after 0.2 seconds.

For the bottom graph, a main battery power source 430 shows a pattern similar to the charger link voltage 420.

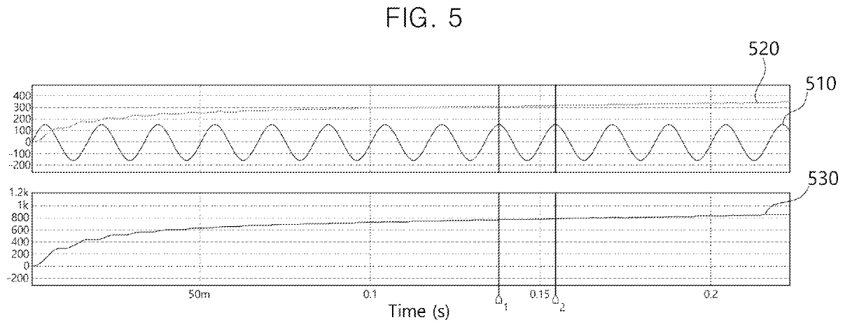

FIG. 5 is a result graph according to another setting of the input values based on FIG. 3. Referring to FIG. 5, the setting of the input values is as follows.

AC input power source=110 Vrms

PFC duty=0.5

DC-DC duty=0.47

Link voltage (Vlink)=313 V

Main battery power source (VHVB)=781 V

Continuously referring to FIG. 5, for the top graph, as a charger input voltage 510 is input within a range of about +150 to −150 V, a charger link voltage 520 initially increases rapidly but becomes almost flat as it approaches 50 msec, and becomes a flat state after 0.15 seconds.

For the bottom graph, a main battery power source 530 shows a pattern similar to the charger link voltage 520.

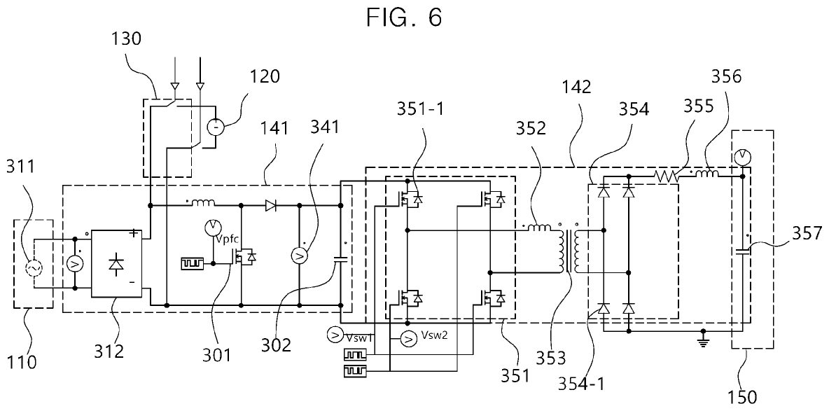

FIG. 6 is a concept diagram showing the initial charging operation of the connection terminal connected to the main battery in a traveling situation as an example of the circuit diagram of the charging apparatus shown in FIG. 1. FIG. 6 is a circuit diagram that is the same as in FIG. 3, but there is no AC system power source, and the auxiliary battery 120 is in a state of being electrically connected to the charger 140 by the ON operation of the first switch 130.

The initial charging on the connection terminal 150 connected to the main battery 170 in the situation where the AC system power source is not applied is performed by turning on the first switch 130 connected to the charger 140 and adjusting the duties of the boosting switch 301 and the primary side switch 351-1. In other words, the boosting switch 301 is turned on when the input voltage is larger than a reference value (Vpfc). In addition, the primary side switches 351-1 are also turned on when the input voltages are larger than reference values (Vdcdc1, Vdcdc1_).

Then, power components such as the inverter and the LDC using the main battery 170 are driven.

FIGS. 3 and 6 show that the charger is the unidirectional charger, but all kinds of chargers can perform the corresponding initial charging operation regardless of the unidirectionality/bidirectionality, the type of PFC circuit, and the type of DC-DC circuit of the charger.

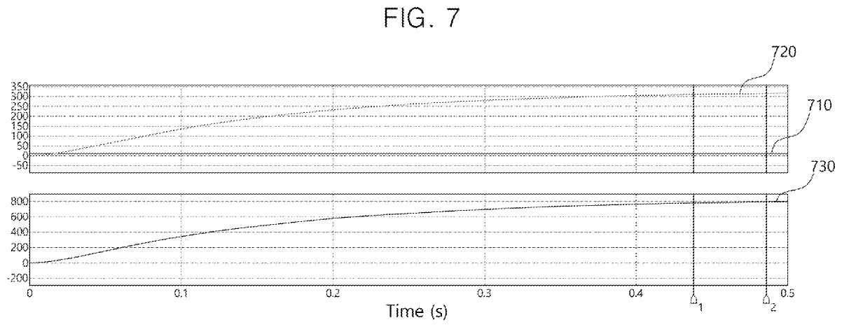

FIG. 7 is the result graph according to the setting of input values based on FIG. 6. Referring to FIG. 7, the setting of the input values is as follows.

Charger input power source=12 Vdc

PFC duty=0.965

DC-DC duty=0.488

Link voltage (Vlink)=314 V

Main battery power source (VHVB)=784 V

Continuously referring to FIG. 7, for the top graph, as a charger input voltage 710 is input at about 12 V, a charger link voltage 720 initially increases rapidly but smoothly increases after 0.1 seconds, and becomes almost flat after 0.4 seconds.

For the bottom graph, a main battery power source 730 shows a pattern similar to the charger link voltage 720.

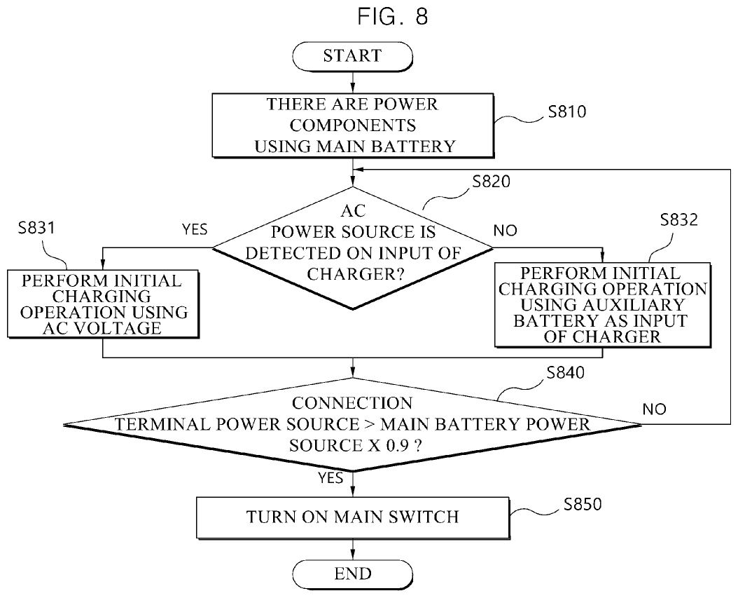

FIG. 8 is a flowchart showing a process of performing the initial charging without the initial charging circuit using the auxiliary battery according to an exemplary embodiment of the present disclosure. Referring to FIG. 8, first, when there are power components such as the inverter and the LDC using the main battery 170, the control unit 180 confirms whether the AC system power source is detected on the input of the charger 140 (steps S810, S820).

In step S820, as the confirmation result, when the AC system power source is detected, the initial charging operation is performed by using the AC system power source (step S831).

In contrast, in the step S820, as the confirmation result, when the AC system power source is not detected, the initial charging operation is performed by using the auxiliary battery as the input of the charger (step S832).

When the initial charging operation is completely performed, the initial charging power generated on the connection terminal and a pre-computed reference value are compared (step S840). In other words, for example, the reference value can be the main battery power source×0.9.

In the step S840, as the comparison result, when the initial charging power on the connection terminal is smaller than the reference value, it proceeds to the step S820 and the steps S820, S831, S832, and S840 are executed again.

In contrast, in the step S840, as the comparison result, when the initial charging power on the connection terminal is larger than the reference value, the main switch (i.e., the second switch 160) is turned on to electrically connect the connection terminal 150 with the main battery 170 (step S850).

In addition, some of the steps of the method or algorithm described in connection with the exemplary embodiments disclosed herein can be implemented in the form of program instructions that can be performed through various computer means such as a microprocessor, a processor, and a central processing unit (CPU) and recorded on a computer-readable medium. The computer-readable medium can include program (instruction) codes, data files, data structures, etc. alone or in combination.

The program (instruction) code recorded on the medium can be ones specially designed and configured for the present disclosure, or can also be ones known and available to those skilled in the art of computer software. Examples of computer-readable recording media can include magnetic media such as a hard disk, a floppy disk, and a magnetic tape, optical media such as a CD-ROM, a DVD, and a Blu-ray, and semiconductor memory elements specially configured to store and execute the program (instruction) code such as a ROM, a RAM, and a flash memory.

Here, examples of the program (instruction) code include high-level language codes that can be executed by a computer using an interpreter, etc. as well as machine language codes such as those generated by a compiler. The aforementioned hardware devices can be configured to operate as one or more software modules to perform the operations of the present disclosure, and vice versa.

What is claimed is:

1. A charging apparatus comprising:
a main battery;
a charger configured to generate an initial charging power source by receiving a direct current (DC) power source from an auxiliary battery installed in a vehicle separately from the main battery or by receiving an alternating current (AC) power source to execute an initial charging operation; and
a first switch configured to block or conduct an electrical connection between the auxiliary battery and the charger to thereby execute the initial charging operation depending upon whether the AC power source is supplied;
wherein the initial charging operation is terminated when the initial charging power source reaches a preset reference value calculated by multiplying an output power source of the main battery by a preset setting value; and
wherein when the AC power source is not supplied, the first switch is turned on to conduct the electrical connection between the auxiliary battery and the charger.

2. The charging apparatus of claim 1, wherein the initial charging operation comprises performance of an initial charging by turning on the first switch and adjusting duties of a boosting switch for boosting configured in a correction unit of the charger and a primary side switch configured in a conversion unit of the charger.

3. The charging apparatus of claim 1, further comprising a second switch disposed between the main battery and a connection terminal, wherein the second switch is configured to be changed from OFF to ON depending upon a comparison result obtained by comparing the initial charging power source generated on the connection terminal connected to the main battery by executing the initial charging operation with the preset reference value.

4. The charging apparatus of claim 3, wherein the second switch is connected between the connection terminal and the main battery with the same polarity and comprises a first sub-switch and a second sub-switch arranged in parallel.

5. The charging apparatus of claim 3, wherein a low voltage direct current-direct current converter (LDC) among power components connected to the connection terminal is a unidirectional LDC.

6. The charging apparatus of claim 1, wherein the first switch is in a turned on state when the vehicle travels or requires an initial charging.

7. The charging apparatus of claim 1, wherein when the AC power source is supplied, the first switch is in a turned off state to block the electrical connection between the auxiliary battery and the charger.

8. The charging apparatus of claim 7, wherein the initial charging operation comprises performance of an initial charging by turning off the first switch and adjusting duties of a boosting switch for boosting configured in a correction unit of the charger and a primary side switch configured in a conversion unit of the charger.

9. A charging method comprising:
switching between blocking and conducting an electrical connection between an auxiliary battery and a charger using a first switch depending upon whether an alternating current (AC) power source is supplied, wherein switching comprises conducting the electrical connection between the auxiliary battery and the charger by turning on the first switch when the AC power source is not supplied;
executing an initial charging operation by receiving a direct current (DC) power source from the auxiliary battery using the charger installed in a vehicle separately from a main battery or receiving the AC power source to generate an initial charging power source; and
terminating the initial charging operation when the initial charging power source reaches a preset reference value calculated by multiplying an output power source of the main battery by a preset setting value.

10. The method of claim 9, wherein the initial charging operation comprises performing an initial charging by turning on the first switch and adjusting duties of a boosting switch for boosting configured in a correction unit of the charger and a primary side switch configured in a conversion unit of the charger.

11. The method of claim 9, wherein terminating the initial charging operation comprises:
comparing a charging power source generated on a connection terminal connected to a main battery by executing the initial charging operation with a preset reference value; and
changing a second switch disposed between the main battery and the connection terminal from OFF to ON depending upon the comparison result.

12. The method of claim ii, wherein the first switch is turned on when the vehicle travels or requires the initial charging.

13. The method of claim 9, wherein switching comprises blocking the electrical connection between the auxiliary battery and the charger by turning off the first switch when the AC power source is supplied.

14. The method of claim 13, wherein the initial charging operation comprises performing the initial charging by turning off the first switch and adjusting duties of a boosting switch for boosting configured in a correction unit of the charger and a primary side switch configured in a conversion unit of the charger.

15. A charging method comprising:
electrically connecting an auxiliary battery and a charger when an alternating current (AC) power source is not supplied;
executing an initial charging operation by receiving a direct current (DC) power source from the auxiliary battery using the charger installed in a vehicle separately from a main battery; and
terminating the initial charging operation when the initial charging power source reaches a preset reference value calculated by multiplying an output power source of the main battery by a preset setting value.

16. The charging method of claim 15, further comprising:
blocking the electrical connection between the auxiliary battery and the charger when the AC power source is supplied; and
executing the initial charging operation by receiving the AC power source to generate an initial charging power source.

17. The charging method of claim 16, wherein the initial charging operation comprises performing an initial charging by turning on a switch between the auxiliary batter and the charger and adjusting duties of a boosting switch for boosting configured in a correction unit of the charger and a primary side switch configured in a conversion unit of the charger.

18. The charging method of claim 16, wherein terminating the initial charging operation comprises:
comparing a charging power source generated on a connection terminal connected to a main battery by executing the initial charging operation with a preset reference value; and
changing a switch disposed between the main battery and the connection terminal from OFF to ON depending upon the comparison result.

19. The charging method of claim 18, wherein a first switch between the auxiliary battery and the charger is turned on when the vehicle travels or requires the initial charging.

20. The charging method of claim 19, wherein the initial charging operation comprises performing the initial charging by turning off the first switch and adjusting duties of a boosting switch for boosting configured in a correction unit of the charger and a primary side switch configured in a conversion unit of the charger.
